(19) United States
(12) Patent Application Publication
(10) Pub. No.: US 2010/0223490 A1
(43) Pub. Date: Sep. 2, 2010

(54) ASSESSING INTELLECTUAL PROPERTY INCORPORATED IN SOFTWARE PRODUCTS

(75) Inventors: Heather Maria Hinton, Austin, TX (US); Jeffrey R. Dean, Austin, TX (US)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/395,879

(22) Filed: Mar. 2, 2009

(51) Int. Cl. G06F 11/28; G06F 11/07; G06N 5/02

(52) U.S. Cl. 714/2; 714/38; 706/47; 714/E11.023; 714/E11.178

(57) ABSTRACT

A method, system, and computer usable program product for assessing third-party IP that may be incorporated in a software product are provided in the illustrative embodiments. An instance of the third-party's intellectual property is identified in a component of the product. The instance is classified as actionable, or not actionable. A remediation action is identified for an actionable instance. An entry is created in a remediation report, the entry including information identifying the actionable instance, the remediation action, or a combination thereof. The remediation report is published. A context of the actionable instance may be determined. Based on the context and the actionable instance, a remediation rule may be selected and executed from a set of remediation rules. The output of the remediation rule may be reported as the remediation action in the remediation report. Performing the remediation action may cause manipulation or initiation of a workflow.

### RELATED APPLICATION

The present invention is related to similar subject matter of co-pending and commonly assigned U.S. patent application Ser. No. ______ (Attorney Docket No. AUS920080785US1) entitled “CODE COMPONENT LEVEL INTELLECTUAL PROPERTY REMEDIATION,” filed on ______ 2009, which is hereby incorporated by reference.

### BACKGROUND OF THE INVENTION

1. Field of the Invention

The present invention relates generally to an improved data processing system, and in particular, to a computer implemented method for analyzing a software product. Still more particularly, the present invention relates to a computer implemented method, system, and computer usable program code for assessing third-party's intellectual property (third-party IP) that may be incorporated in a software product.

b 2. Description of the Related Art

A software product is a collection of various types of code, text, and data. For example, a software product may include a computer file that may include instructions to be executed by a computer, the instructions being in a high level programming language, object code, or machine language. The software product may include data, such as in a database, for performing a desired function. The software product may further include a file that includes text or instructions, such as license information, for use during the code execution.

A user may analyze a software product for a variety of reasons. For example, a user may analyze a software product for identifying or correcting errors, for inclusion or removal of testing information, for inclusion or exclusion of authorized or unauthorized information, and many other reasons. Analyzing a software product is analyzing any or all components of the software product. For example analyzing a software product may include analyzing only the code, a portion of the code and a portion of the text files, or some combination of the code, text, and data associated with the software product.

Software products often include portions that may be protected by intellectual property rights. The software manufacturer, the customer, or a third-party may own these IP rights. As an example, the third-party may be another manufacturer or an open-source code provider.

### SUMMARY OF THE INVENTION

The illustrative embodiments provide a method, system, and computer usable program product for assessing third-party IP that may be incorporated in a software product. An instance of the third-party's intellectual property is identified in a component of the product. The identification is made by scanning a copy of the product stored in a computer memory for the presence of an identifier associated with the third-party's intellectual property. The instance is classified as actionable, or not actionable. A remediation action is identified for an actionable instance. An entry is created in a remediation report, the entry including information identifying the actionable instance, the remediation action, or a combination thereof. The remediation report is published.

In an embodiment, a context of the actionable instance may be determined. Based on the context and the actionable instance, a remediation rule may be selected and executed from a set of remediation rules. As a part of creating the entry, the output of the remediation rule may be reported as the remediation action in the remediation report.

In another embodiment, the context is determined from a source external to the product. In another embodiment, the remediation rule may cause a performance of an action corresponding to the remediation action.

In another embodiment, the performance of the remediation action may result in manipulation of a workflow or initiation of a workflow. The manipulation of the workflow may include manipulating a part of the product, negotiating a license to use the instance in the product, or a combination thereof. In another embodiment, the action may be distinct from the remediation action.

In another embodiment, a second entry may be created in the remediation report for a not actionable instance. The second entry may also include a reason why the not actionable instance is not actionable.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts third-party IP inclusion in an example code with respect to which an illustrative embodiment may be practiced;

FIG. 4 depicts an analysis table in accordance with an illustrative embodiment;

FIG. 5 depicts a block diagram of a process of generating a remediation report in accordance with an illustrative embodiment;

FIG. 6 depicts an example rule that may be used for recommending remediation action in accordance with an illustrative embodiment;

FIG. 7 depicts an example remediation report in accordance with an illustrative embodiment;

FIG. 8 depicts a flowchart of a process of producing remediation reports in accordance with an illustrative embodiment;

FIG. 9 depicts a flowchart of a process determining a remediation action in accordance with an illustrative embodiment; and

FIG. 10 depicts a flowchart of a process of taking a remediation action in accordance with an illustrative embodiment.

### DETAILED DESCRIPTION OF THE PREFERRED EMBODIMENT

A portion of a software product may be protected by one or more intellectual property (IP) assets such as patent, trademark, or copyright. The illustrative embodiments recognize that before such a software product can be released for use, the manufacturer may want to ensure that any included IP assets are suitably licensed. Furthermore, the illustrative embodiments recognize that the manufacturer may also want to know whether any licensed IP asset included in the software product causes unintended conflict, lapse, or release of other IP rights associated with the same or different software product.

As an example, normally, a software manufacturer desires to keep the source code of their software product a secret. However, using segments of open-source software code under certain open-source licensing agreements within the software product may subject the otherwise proprietary code of a software product to full disclosure.

Currently, tedious review of the code is performed to reveal the above described IP licensing issues and other similar. IP asset related problems. The illustrative embodiments recognize that such a method of assessing IP in a software product is time consuming, error prone, and labor intensive. The illustrative embodiments further recognize that currently, even when third-party IP is identified in a software product, further work is needed to act on such inclusions on a case by case basis. For example, currently, if a user, who may be reviewing the code, finds an open-source licensed code segment in the software product, the user may be left to his or her own thought process to determine what to do with the finding. One user may escalate the issue to a supervisor, whereas another user may ignore the inclusion. Yet another user may rework the code to isolate or eliminate the inclusion. The illustrative embodiments recognize that current method of assessing third-party IP inclusions in a software product may lead to inconsistent and even undesirable actions by the users.

To address these and other related problems in present methods of dealing with third-party IP inclusions in software products, the illustrative embodiments provide a method, computer usable program product, and data processing system for assessing third-party IP that may be incorporated in a software product. Using the illustrative embodiments, a software manufacturer can implement automated analysis of software products for identifying third-party IP inclusions therein. Using the illustrative embodiments, the manufacturer can further implement uniform processes for managing the third-party IP inclusions by remedial actions.

Remedial action, or remediation, is an action that manipulates the included third-party IP. Such manipulation may be within the software product, such as by code change, or outside of the software product, such as by someone engaging in a license negotiation. The end-result of the manipulation is to make the inclusion acceptable to the software manufacturer when the software product is released for its intended use. A remediation report is a report that identifies third-party IP inclusions and suggests a remedial action with respect to the third-party IP inclusions.

The examples in this disclosure are used only for the clarity of the description and are not limiting on the illustrative embodiments. Additional operations, actions, tasks, activities, and manipulations will be conceivable from this disclosure and the same are contemplated within the scope of the illustrative embodiments.

The illustrative embodiments are described using code, files, and databases only as examples and are not limiting on the illustrative embodiments. The illustrative embodiments may be implemented with respect to any type of data and any type of IP that can be used in a software product. Furthermore, the illustrative embodiments are described in some instances using particular data processing environments only as an example for the clarity of the description. The illustrative embodiments may be used in conjunction with other comparable or similarly purposed systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

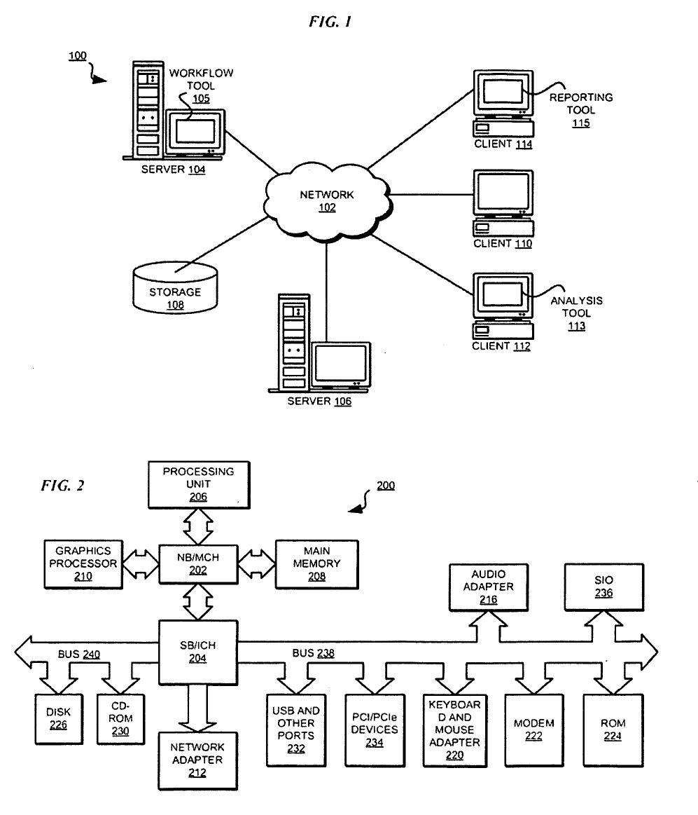

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may have software applications or software tools executing thereon. For example, server 104 may include workflow tool 105 executing thereon. Workflow tool 105 may be a software application that facilitates planning and executing tasks. Similarly, client 112 may include analysis tool 113. As an example, analysis tool 113 may analyze code or other information associated with a software product for identifying third-party IP inclusions. Analysis cools are also known as code scanning tools.

Client 114 may include reporting tool 115 executing thereon. Reporting tool 115 may, for example, generate remediation reports using the analysis performed by analysis tool 113.

Servers 104 and 106, storage units 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

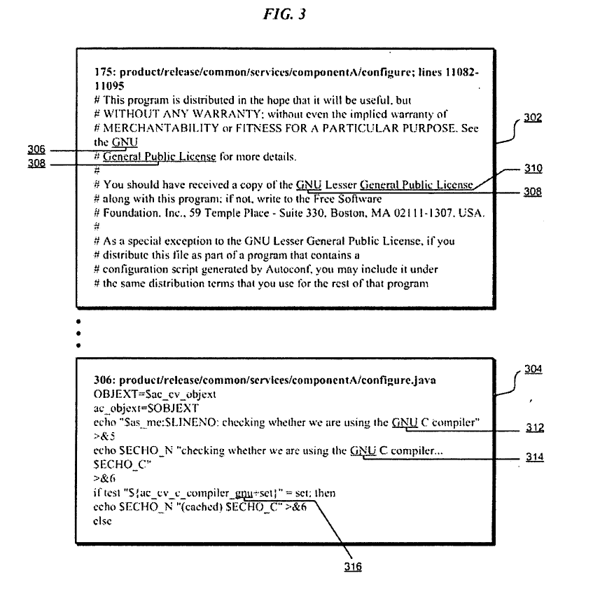

With reference to FIG. 3, this figure depicts third-party IP inclusion in an example code with respect to which an illustrative embodiment may be practiced. Code 300 may be code belonging to a software product being analyzed by analysis tool 113 in FIG. 1.

Segment 302 may be notes, comments, information, or other non-executable portion of code 300. Segment 304 may be instructions in code 300 that a data processing system may execute.

An analysis tool, such as analysis tool 113 in FIG. 1, may be configured to detect the presence of certain identifiers, such as words, keywords, phrases, symbols, acronyms, or alphanumeric codes, that may identify a third-party IP. As an example, an analysis tool may be configured to analyze code 300 and detect the presence of identifiers “GNU”, “General Public License”, “GPL”, or other similar identifiers that may indicate the presence of open-source licensed code in code 300.

Identifiers 306, 308, 310, and 312 are examples of identifiers that the analysis tool may detect in segment 302 of code 300. Identifiers 312, 314, and 316 are examples of identifiers that the analysis tool may detect in segment 304 of code 300.

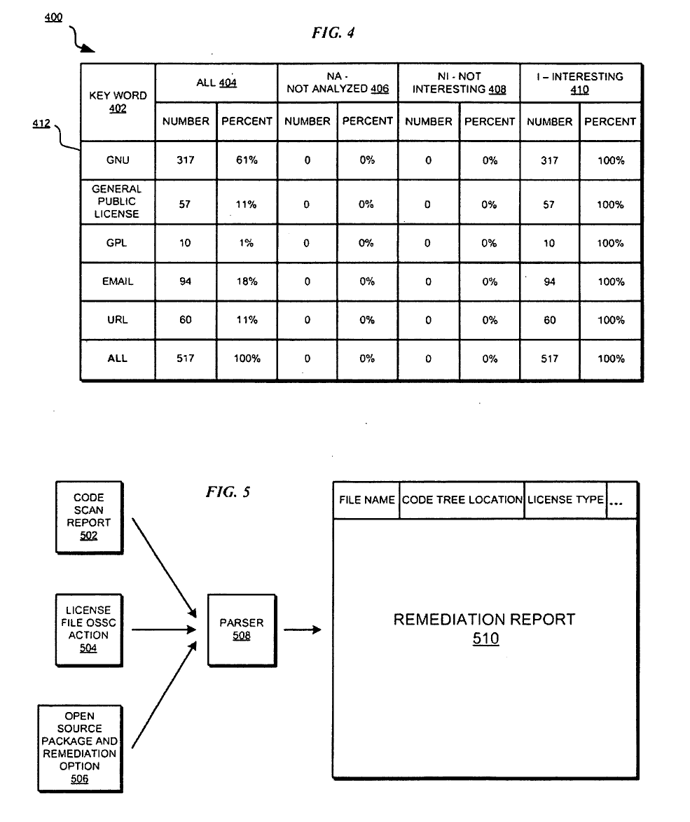

With reference to FIG. 4, this figure depicts an analysis table in accordance with an illustrative embodiment. Table 400 may be included in a code scan report output of an analysis tool, such as analysis tool 113 in FIG. 1.

As an example, code 300 in FIG. 3 may be a portion of a software product. Table 400 may include entries resulting from the analysis of that software product, including code 300 in FIG. 3.

In the depicted example table 400, column 402 lists identifiers for which the analysis tool scanned the software product. Column 404 may list number of instances, percentage of occurrence, or both, of a particular identifier in the software product. Column 406 may list as number, percentage, or both, instances of a particular identifier that is not analyzed for the data in columns 408 and 410.

Column 408 may list as number, percentage, or both, instances of a particular identifier that may not be interesting. An instance of an identifier is not interesting if the instance does not have to be investigated further for any remedial action. For example, identifier 306 in FIG. 3 may be not interesting because identifier 306 occurs in comments of code 300 and therefore is not really an inclusion of third-party IP but only a reference thereto.

Column 410, on the other hand, may list as number, percentage, or both, instances of a particular identifier that may be interesting. An instance of an identifier is interesting if the instance may have to be investigated further for one or more remedial action. For example, identifier 316 in FIG. 3 may be interesting because identifier 316 occurs in code segment 304 of code 300 and therefore may be an actual inclusion of third-party IP

Consider row 412 as an example of the currently available analysis. Presently, once the instances of identifier “GNU” in column 402 of row 412 are identified in code 300 of FIG. 3, a user would have to manually determine what remediation action to take with respect to each of those instances. As depicted in row 412, every instance of identifier “GNU” is presently deemed to be interesting because present analysis techniques, without the benefit of the illustrative embodiments, lack the ability to distinguish between interesting and not interesting instances of identifiers.

The illustrative embodiments provide an automated method, program product, and system for distinguishing between interesting and not interesting instances of various identifiers. Furthermore, the illustrative embodiments provide recommendations on remediation associated with one or more instances of the identifiers. Additionally, the illustrative embodiments may automatically perform one or more remediation actions or portions thereof in response to an instance of an identifier. These and other aspects of the illustrative embodiments will become apparent from the description of subsequent figures and illustrative embodiments.

With reference to FIG. 5, this figure depicts a block diagram of a process of generating a remediation report in accordance with an illustrative embodiment. Code scan report 502 may include table 400 in FIG. 4, and may be generated by code scanning tools such as analysis tool 113 in FIG. 1.

Code scan report 502 may be formatted any format suitable for a particular implementation. For example, particular implementations of the illustrative embodiments may format code scan report 502 in extensible markup language (XML), comma separated value file (CSV), or other suitable formats, such as a spreadsheet or a database table.

The illustrative embodiment may combine any number of additional information inputs with code scan report 502. As an example, FIG. 5 depicts combining knowledge-bases 504 and 506 with code scan report 502. Knowledge-base 504, for example, may be a source of information about various common license file types available for various third-party IP that is likely to be included in a manufacturer's software products.

Knowledge-base 506, as another example, may be a source of information about known remediation options for some or all of those license types. For example, a manufacturer may have compiled in the form of knowledge-base 506, information about what remediation action to take when certain identifiers are detected in certain parts of a software product. Some example remediation actions described in knowledge-base 506 may be to replace the third-party IP protected code with an alternate package, or re-write a portion of code affected by third-party IP to eliminate the third-party IP protected portion of the code.

The illustrative embodiment parses code scan report 502 and one or more knowledge-base inputs using parser 508. Parser 508 may analyze the various inputs and correlate the information contained therein. For example, parser 508 may locate an instance of an identifier in code scan report 502. Parser 508 may then match the context of the instance with entries in knowledge-base 504 to determine if the instance occurs within a description of a known license.

Additionally, parser 508 may identify a remediation option from knowledge-base 506 for the instance, the context of the instance, the additional information about the instance received from knowledge-base 504, or a combination thereof. Parser 508 may generate remediation report 510.

Remediation report 510 may include any information suitable for remedying an issue with a third-party IP identified in a software product. For example, one embodiment of remediation report 510 may include the name of the file, location in the code in that file, and type of license associated with a particular instance of an identifier. Remediation report 510 may also categorize the instances of the various identifiers as interesting or not interesting.

An embodiment of remediation report 510 may further include a recommendation about specific remediation action for that instance. Another embodiment of remediation report 510 may include the result of a remediation action automatically performed with respect to that instance. Another embodiment of remediation report 510 may include a combination of recommendations and results of remediation actions for the instance. Another embodiment of remediation report 510 may simply perform the remediation action without including additional information in remediation report 510.

Additional embodiments of remediation report 510 will become apparent from this disclosure. An implementation may combine these embodiments and other variations of remediation report 510 without departing from the scope of the illustrative embodiments.

The operation of parser 508 is described only as an example to illustrate the operation of an illustrative embodiment using example knowledge-bases. This example operation is not limiting on the illustrative embodiments as many other parsing, combining, analyzing, refining, and deducing operations are conceivable from this disclosure at parser 508.

For example, additional knowledge-bases, such as a build file (not shown), may be incorporated in the process of FIG. 5. A build file generally includes a list of code, text, and data files that may be included in all or part of a software product.

As an example, including a build file into the process of FIG. 5 may enable an illustrative embodiment to determine if an instance of an identifier is invoked or executed in the product even though the instance may have been found in a file. If the instance is detected in a file that is compiled according to the build file, the instance may be marked as interesting.

Conversely, if, using the build file, the illustrative embodiment determines that although the instance of the identifier is present in a file, the file is not compiled into the software product, the illustrative embodiment may mark the instance as not interesting. An embodiment of the illustrative embodiment may also generate a report indicating files to be removed from the source code tree if the files including the instances are not used in the software product. Another embodiment may use a “build file” or a “make file” as an input and remove those files that are not compiled or otherwise used from the code tree. By performing such a removal, the process of the illustrative embodiment may be expedited as the illustrative embodiment need not perform an interesting/not-interesting determination of the instances in such files.

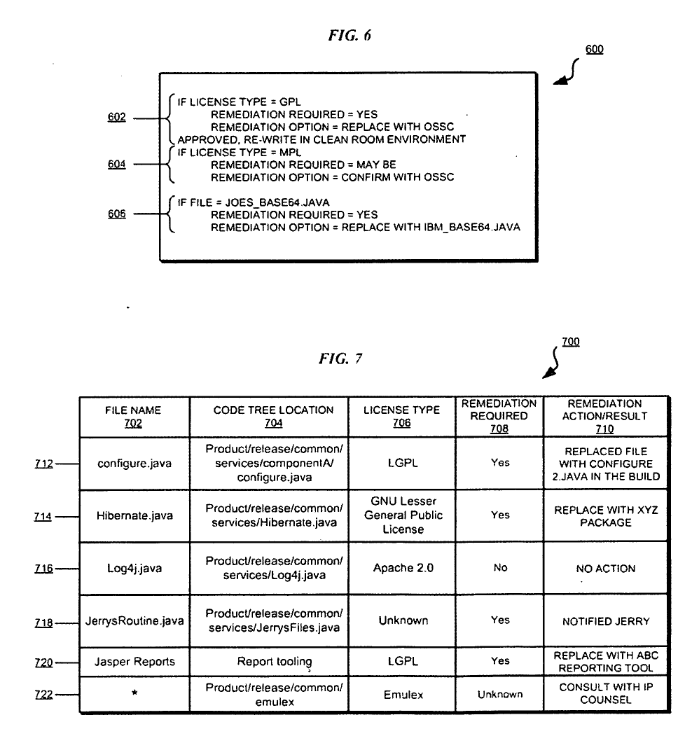

With reference to FIG. 6, this figure depicts an example rule that may be used for recommending remediation action in accordance with an illustrative embodiment. Rule 600 may be used by parser 508 in FIG. 5 for recommending remediation action for an instance of an identifier in remediation report 510 in FIG. 5. For example, rule 600 may be implemented in code, .which can be executed by a data processing system that may be executing a software implementation of parser 508 in FIG. 5.

As an example, rule 600 may be used when an instance of an identifier is encountered in a code scan report, such as code scan report 502 in FIG. 5. Once a parser, such as parser 508 in FIG. 5, correlates the instance to a license type of “GPL” (General Public License), the parser would execute portion 602 of rule 600. If, on the other hand, the parser determines that the instance correlates to a license type of “MPL” (Mozilla Public License), the parser would execute portion 604 of rule 600.

According to portion 602 of rule 600, the parser would mark the instance in the remediation report as requiring remediation. The parser would further describe the remediation action as provided in portion 602 of rule 600. According to portion 604, the parser would mark the instance in the remediation report as an instance that may or may not require remediation. Thus, for some instances the parser may indicate that additional investigation of the context of the instance may have to be performed. Additionally, as in portion 604 of rule 600, the parser may include in the remediation report which entity should perform the investigation, remediation, or both.

Another remediation option may be a known file replacement. For example, portion 606 may cause the parser to search for or otherwise identify inclusions of known file in the software product. In portion 606, the parser may identify a third-party file called “joes_base64.java” that may be included in a given software product. Portion 606 may cause the parser to automatically perform a replacement of this known file with a substitute file, such as for example, “ibm_base64.java”. One embodiment of portion 606 may include instructions for the parser to perform a global search within the software product and perform similar substitutions. Another embodiment of portion 606 may include instructions for the parser to perform a limited search of a certain scope within the software product and perform similar substitutions if the included third-party file meets certain other zero or more conditions.

With reference to FIG. 7, this figure depicts an example remediation report in accordance with an illustrative embodiment. Remediation report 700 may be similar to remediation report 510 in FIG. 5.

One embodiment of remediation report 700 may include for a particular instance of an identifier, the name of the file as in column 702, location in the code in that file as in column 704, and type of license associated with the instance as in column 706. Remediation report 700 may also categorize the instances of the various identifiers as requiring remediation, not requiring remediation, or remediation requirement being uncertain, as in column 708.

An embodiment of remediation report 700 may further include a recommendation or information about specific remediation action for that instance, as in column 710. For example, remediation report 700 is shown to include as an example the result of a remediation action automatically performed with respect to an instance of an identifier in row 712. As another example, remediation report 700 is shown to include a recommendation for a remediation action with respect to an instance of an identifier in row 714.

As another example, remediation report 700 is shown to conclude that no remediation is necessary for the instance in row 716, and accordingly includes a notice of no remediation in column 710 of row 716. Column 710 in row 718 shows as an example that a remediation action was automatically performed. Column 710 in row 720 shows as another example a recommendation for remediation action. Column 710 in row 722 depicts example information or instruction when the parser may be uncertain whether a remediation action is to be performed.

Remediation report 700 illustrates a variety of remediation actions and results in column 710 only as examples. A remediation report according to the illustrative embodiments is not limited to these actions or results. Many other remediation actions, instructions, results, and outputs will be conceivable from this disclosure and the same are contemplated within the scope of the illustrative embodiments.

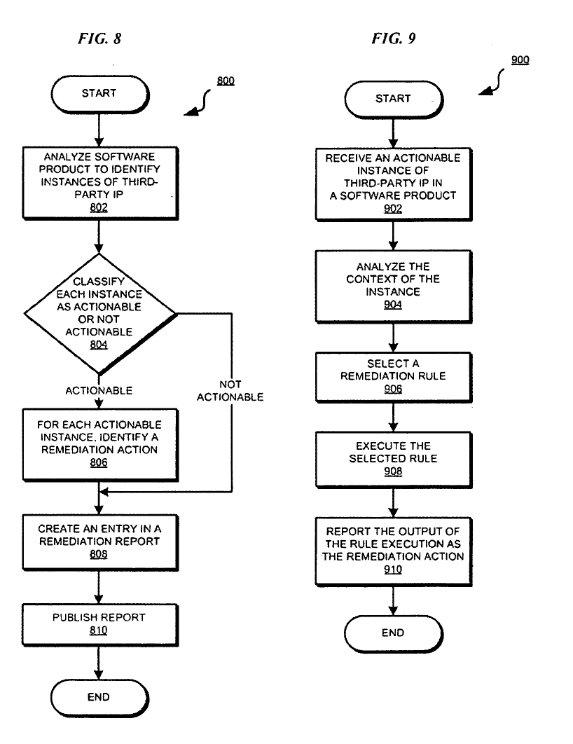

With reference to FIG. 8, this figure depicts a flowchart of a process of producing remediation reports in accordance with an illustrative embodiment. Process 800 may be implemented using parser 508 in FIG. 5.

Process 800 begins by analyzing a software product to identify instances of identifier that indicate presence of third-party IP in the software product (step 802). Process 800 classifies each instance identified in step 802 as actionable or not actionable (step 804). Actionable instance is an instance with respect to which a remediation action has to be performed. Conversely, an instance is not actionable if no remediation action is to be performed with respect to the instance.

If process 800 determines that an instance is actionable (“ACTIONABLE” path of step 804), process 800 identifies a remediation action for the instance (step 806). Process 800 does not perform step 806 and proceeds to step 808 if the instance is not actionable (“NOT ACTIONABLE” path of step 804).

Process 800 creates an entry in a remediation report (step 808). Remediation report used in process 800 may be similar to remediation report 700 in FIG. 7. Process 800 may create an entry in the remediation report for instances that are actionable, not actionable, or a combination thereof. For certain instances, based on implementation specific rules executed by a parser, such as parser 508 in FIG. 5, process 800 may omit making an entry in the remediation report in step 808.

Process 800 publishes the remediation report thus created in step 808 (step 810). Process 800 ends thereafter. In implementing process 800, a particular implementation may publish the remediation report as in step 810 by making the report physically available to a user or system in any manner suitable for the implementation. For example, an implementation may transmit the report by email over a data network, post the report on a website by storing the report at an associated web server, log the contents of the report in a computer database, print the report at a printing device, display the report on a display device, save a file containing the report in a computer memory, or otherwise publish by any other suitable method.

Additionally, process 800 may include additional steps for executing certain remediation actions with respect to certain instances identified in step 802. Furthermore, process 800 may create multiple entries for an instance in the remediation report in step 808.

With reference to FIG. 9, this figure depicts a flowchart of a process determining a remediation action in accordance with an illustrative embodiment. Process 900 may be implemented as a part of process 800, such as in step 806 in FIG. 8. Furthermore, a parser, such as parser 508 in FIG. 5 may execute process 900.

Process 900 begins by receiving an actionable instance of third-party IP in a software product (step 902). Process 900 analyzes the context of the instance (step 904).

A context of an instance of a third-party IP or an instance of an identifier of third-party IP is additional information surrounding the instance that describes how the instance is being used in the software product. For example, the statement within which the instance of an identifier is found may provide sufficient context for the instance. If the sentence is marked as a comment in code, then the statement as a context of the instance provides that the instance may be a non-actionable instance. Conversely, if the statement is an executable statement, the statement as a context of the instance may provide that the instance has to be remedied.

A context may be any information in a given implementation. In one embodiment, the context may be a name of the file within which the instance is detected. In another embodiment, the context may be a statement in another part of the software product, such as in a header of same or different file. In another embodiment, the context may be obtained from searching a document external to the software product, such as a corporate policy. A particular implementation may identify the context of an instance in any manner suitable for the implementation without departing the scope of the illustrative embodiments.

Based on the instance, the context of the instance, or a combination thereof, process 900 may select a set of remediation rules (step'906). A set of remediation rules is one or more remediation rules. Process 900 may execute all or a subset of the set of remediation rules (step 908). Process 900 may report the output of the rule execution as the remediation action to be performed with respect to the instance of step 902 (step 910). Process 900 ends thereafter.

In one embodiment, executing a remediation rule, as in step 908, may cause process 900 to automatically perform the remediation action. Consequently, step 910 may alternatively report an outcome of the remediation action within the scope of the illustrative embodiments.

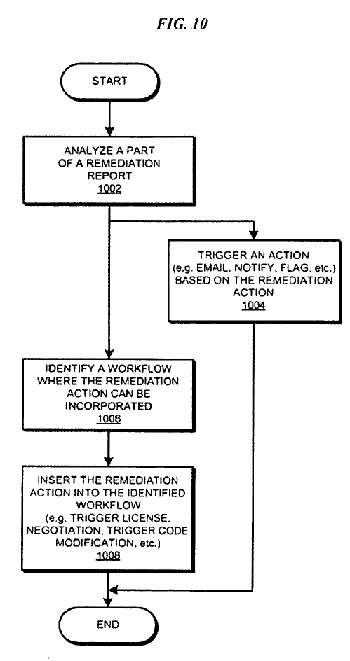

With reference to FIG. 10, this figure depicts a flowchart of a process of taking a remediation action in accordance with an illustrative embodiment. Process 1000 may be implemented as a part of process 900, such as in steps 908-910 in FIG. 9. Alternatively, process 1000 may be executed following step 810 in FIG. 8. Furthermore, a parser, such as parser 508 in FIG. 5 may execute process 1000.

Process 1000 begins by analyzing a part of a remediation report (step 1002). In another embodiment, process 1000 may begin by executing a remediation rule, such as in step 908 in FIG. 9 (not shown).

Depending on the analysis of step 1002 or rule execution (not shown), process 1000 may take one or both of two paths. In following the first of the two paths, process 1000 may trigger an action (step 1004). Process 1000 may end thereafter. Some examples of the action being triggered may be sending an email to a developer, notifying an IP counsel, flagging a part of the code in a code repository, or other action suitable for a particular implementation. Additionally, the action may be based on a remediation action identified from the analysis of the remediation report or rule execution.

In following the second path of the two paths, process 1000 may identify a workflow within which the remediation action can be incorporated (step 1006). Process 1000 may insert the remediation action into the identified workflow (step 1008). Process 1000 may end thereafter.

For example, the remediation action may be to re-write a portion of the code to remove the third-party IP. Process 1000 may incorporate a rewrite task in a software development plan or workflow. Consequently, when software development of the software product reaches that point in the workflow, the remediation action is executed as a part of the modified workflow.

As another example, the remediation action may be to negotiate or renegotiate a license for the third-party IP. Process 1000 may insert a negotiation task into an IP counsel's calendar with a checklist of negotiation points based on the instance being analyzed. The IP counsel may then have ready information to perform the negotiation at the determined time.

The components in the block diagrams and the steps in the flowcharts described above are described only as examples. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments assessing third-party IP that may be incorporated in a software product. Using the illustrative embodiments, a manufacturer can automate the process of analyzing dependencies on third-party IP within the manufacturer's software products.

Additionally, using the illustrative embodiments, the manufacturer may be further able to determine the specific remedial actions that may have to be taken with respect to specific instances of third-party IP in a software product. The remediation action determination can be performed automatically or in conjunction with a manual process.

The illustrative embodiments include remediation rules that facilitate the determination of remediation actions. In certain embodiments, the remediation rules may also automatically trigger the remediation actions.

Furthermore, the illustrative embodiments may cause remediation actions that may result in code change, or coding based software product changes to remediate an instance of a third-party IP. The illustrative embodiments may also cause remediation actions that result in a negotiation process that may leave the instance of the third-party IP intact but change the terms of license for using that instance.

An implementation of the illustrative embodiments may use any knowledge-base that may provide information useful in determining a remediation action. The illustrative embodiments may produce a remediation report, perform remediation actions, or modify workflows for remedying instances of third-party IP in software products. Although the illustrative embodiments have been described with respect to third-party IP in software products, the illustrative embodiments are similarly usable in other types of non-computer software products, such as for remedying third-party's copyright in authored works.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for assessing third-party's intellectual property in a product, the computer implemented method comprising:
identifying an instance of the third-party's intellectual property in a component of the product by scanning a copy of the product stored in a computer memory for the presence of an identifier associated with the third-party's intellectual property;
classifying the instance as one of (i) actionable, and (ii) not actionable;
identifying a remediation action for an actionable instance;
creating an entry in a remediation report, the entry including at least (i) information identifying the actionable instance and (ii) the remediation action; and
publishing the remediation report.

2. The computer implemented method of claim 1, further comprising:
determining a context of the actionable instance;
selecting, based on the context and the actionable instance, a remediation rule from a set of remediation rules;
executing the selected remediation rule; and
reporting, as a part of creating the entry, the output of the remediation rule as the remediation action in the remediation report.

3. The computer implemented method of claim 2, wherein the context is determined from a source external to the product.

4. The computer implemented method of claim 2, wherein the remediation rule causes a performance of an action corresponding to the remediation action.

5. The computer implemented method of claim 4, wherein the performance of the remediation action results in manipulation of a workflow, and wherein the manipulation of the workflow comprises one of (i) manipulating a part of the product, and (ii) negotiating a license to use the instance in the product.

6. The computer implemented method of claim 4, wherein the action is distinct from the remediation action.

7. The computer implemented method of claim 1, further comprising:
creating a second entry in the remediation report for a not actionable instance.

8. A computer usable program product comprising a computer usable medium including computer usable code for assessing third-party's intellectual property in a product, the computer usable code comprising:
computer usable code for identifying an instance of the third-party's intellectual property in a component of the product by scanning a copy of the product stored in a computer memory for the presence of an identifier associated with the third-party's intellectual property;
computer usable code for classifying the instance as one of (i) actionable, and (ii) not actionable;
computer usable code for identifying a remediation action for an actionable instance;
computer usable code for creating an entry in a remediation report, the entry including at least (1) information identifying the actionable instance and (ii) the remediation action; and
computer usable code for publishing the remediation report.

9. The computer usable program product of claim 8, further comprising:
computer usable code for determining a context of the actionable instance;
computer usable code for selecting, based on the context and the actionable instance, a remediation rule from a set of remediation rules;
computer usable code for executing the selected remediation rule; and
computer usable code for reporting, as a part of creating the entry, the output of the remediation rule as the remediation action in the remediation report.

10. The computer usable program product of claim 9, wherein the context is determined from a source external to the product.

11. The computer usable program product of claim 9, wherein the remediation rule causes a performance of an action corresponding to the remediation action.

12. The computer usable program product of claim 11, wherein the performance of the remediation action results in manipulation of a workflow, and wherein the manipulation of the workflow comprises one of (i) manipulating a part of the product, and (ii) negotiating a license to use the instance in the product.

13. The computer usable program product of claim 11, wherein the action is distinct from the remediation action.

14. The computer usable program product of claim 8, further comprising:
computer usable code for creating a second entry in the remediation report for a not actionable instance.

15. The computer program product of claim 8, wherein the computer usable code is stored in a computer readable storage medium in a data processing system, and wherein the computer usable code is transferred over a network from a remote data processing system.

16. The computer program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A data processing system for assessing third-party's intellectual property in a product, the data processing system comprising:
a storage device including a storage medium, wherein the storage device stores computer usable program code; and
a processor, wherein the processor executes the computer usable program code, and wherein the computer usable program code comprises:
computer usable code for identifying an instance of the third-party's intellectual property in a component of the product by scanning a copy of the product stored in a computer memory for the presence of an identifier associated with the third-party's intellectual property;
computer usable code for classifying the instance as one of (i) actionable, and (ii) not actionable;
computer usable code for identifying a remediation action for an actionable instance;
computer usable code for creating an entry in a remediation report, the entry including at least (i) information identifying the actionable instance and (ii) the remediation action; and
computer usable code for publishing the remediation report.

18. The data processing system of claim 17, further comprising:
computer usable code for determining a context of the actionable instance;
computer usable code for selecting, based on the context and the actionable instance, a remediation rule from a set of remediation rules;
computer usable code for executing the selected remediation rule; and
computer usable code for reporting, as a part of creating the entry, the output of the remediation rule as the remediation action in the remediation report.

19. The data processing system of claim 18, wherein the context is determined from a source external to the product.

20. The data processing system of claim 18, wherein the remediation rule causes a performance of an action corresponding to the remediation action, wherein the performance of the remediation action results in manipulation of a workflow, and wherein the manipulation of the workflow comprises one of (i) manipulating a part of the product, (ii) negotiating a license to use the instance in the product, and (iii) initiation of a new workflow.
